(19) United States
(12) Patent Application Publication
(10) Pub. No.: US 2012/0167045 A1
(43) Pub. Date: Jun. 28, 2012

(54) APPARATUS AND METHOD FOR EVALUATING AUTOSAR META FILE-BASED BASIC SOFTWARE PROPERTIES

(75) Inventors: Boo-Sun JEON, Daejeon (KR); Hyun-Soon Nam, Daejeon (KR); Ki-Soon Sung, Daejeon (KR); Joo-Chul Lee, Daejeon (KR); Tae-Man Han, Daejeon (KR)

(73) Assignee: ELECTRONICS AND TELECOMMUNICATIONS RESEARCH INSTITUTE, Daejeon-city (KR)

(21) Appl. No.: 13/335,911

(22) Filed: Dec. 22, 2011

(30) Foreign Application Priority Data
Dec. 23, 2010 (KR) 10-2010-0133941

(51) Int. Cl. G06F 9/44

(52) U.S. Cl. 717/121

(57) ABSTRACT

Disclosed herein is an apparatus for evaluating Automobile Open System Architecture (AUTOSAR) meta file-based basic software properties. The apparatus includes a meta file generation unit, a basic software configuration unit, and a basic software property evaluation unit. The meta file generation unit generates the meta file properties of an AUTOSAR meta file. The basic software configuration unit sets the basic software properties of a basic software configuration file. The basic software property evaluation unit evaluates basic software properties using the meta file properties in order to determine whether the basic software properties were set in conformity with an AUTOSAR standard.

### CROSS REFERENCE TO RELATED APPLICATION

This application claims the benefit of Korean Patent Application No. 10-2010-0133941, filed on Dec. 23, 2010, which is hereby incorporated by reference in its entirety into this application.

### BACKGROUND OF THE INVENTION

1. Technical Field

The present invention relates generally to an apparatus and method for evaluating Automotive Open System Architecture (AUTOSAR) meta file-based basic software properties, and, more particularly, to an apparatus and method for evaluating AUTOSAR meta file-based basic software properties, which evaluates basic software properties using an AUTOSAR meta file, thereby verifying if the properties of an electronic software platform are normally set in conformity with an AUTOSAR standard, which is the standard of a vehicle's electronic software platform architecture.

2. Description of the Related Art

As the electrical and electronic structure of a vehicle becomes more complicated, the amount and degree of complexity of software used to control the vehicle have also increased. Therefore, the period of time required to develop software has increased, and the probability of generating defects in the software has increased. Actually, cases where vehicles which had been released are recalled because of defects in software are continuously reported. Further, with the rapid development of semiconductor and computer technologies, enterprises, which produce the electrical and electronic products of vehicles, have produced new products that have improved performance on a very short cycle. Therefore, vehicle enterprises should also frequently improve vehicle software.

With the increasing importance of the issues of safety and productivity in the vehicle industry, the need for a software platform which assures reliability and reusability has increased. AUTOSAR is the vehicle's electronic software standard platform which has developed for the purpose of such reliability and reusability, and a plurality of vehicle companies are concentrating their energies on developing commercial vehicles on which is mounted platform that was developed based on the AUTOSAR. The AUTOSAR platform includes Electronic Control Units (ECUs) which are basic vehicle control units. Each of the ECUs includes basic software modules used to perform functions, software components which operate on the ECUs, and an AUTOSAR Run-Time Environment (RTE) which supports communication between ECUs. Such a basic software module may be variously set based on the environment and the supported function of an ECU. The AUTOSAR provides a standard for the specification and configuration of each of the basic software modules.

In order to configure a system suitable for specific ECU application to which the AUTOSAR platform is applied, it is necessary to configure a system based on a method proposed by AUTOSAR. Therefore, a tool, used to automatically evaluate whether properties are normally configured in conformity with the AUTOSAR standard, is required.

### SUMMARY OF THE INVENTION

An object of the present invention is to provide an apparatus and method for evaluating AUTOSAR meta file-based basic software properties, which evaluates basic software properties using an AUTOSAR meta file, thereby verifying if the properties of an electronic software platform are normally set in conformity with an AUTOSAR standard, which is the standard of a vehicle's electronic software platform architecture.

In order to accomplish the above object, the present invention provides an apparatus for evaluating Automobile Open System Architecture (AUTOSAR) meta file-based basic software properties including a meta file generation unit for generating the meta file properties of an AUTOSAR meta file; a basic software configuration unit for setting the basic software properties of a basic software configuration file; and a basic software property evaluation unit for evaluating basic software properties using the meta file properties in order to determine whether the basic software properties were set in conformity with an AUTOSAR standard.

In order to accomplish the above object, the present invention provides A method for evaluating AUTOSAR meta file-based basic software properties including: Generating the meta file properties of an AUTOSAR meta file; setting the basic software properties of a basic software configuration file; and evaluating basic software properties using the meta file properties in order to determine whether the basic software properties were set in conformity with an AUTOSAR standard.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view schematically illustrating an apparatus for evaluating AUTOSAR meta file-based basic software properties according to an embodiment of the present invention;

FIG. 2 is a view illustrating an example of a meta file used in the apparatus for evaluating AUTOSAR meta file-based basic software properties according to the embodiment of the present invention;

FIG. 3 is a view illustrating an example of a basic software configuration file set using the apparatus for evaluating AUTOSAR meta file-based basic software properties according to the embodiment of the present invention;

FIG. 4 is a flowchart illustrating a method for evaluating AUTOSAR meta file-based basic software properties according to an embodiment of the present invention;

FIG. 5 is a flowchart illustrating a process of evaluating multiplicity using the apparatus and method for evaluating AUTOSAR meta file-based basic software properties according to the embodiment of the present invention;

FIG. 6 is a flowchart illustrating a process of evaluating reference properties using the apparatus and method for evaluating AUTOSAR meta file-based basic software properties according to the embodiment of the present invention; and

FIG. 7 is a flowchart illustrating a process of evaluating hierarchy properties using the apparatus and method for evaluating AUTOSAR meta file-based basic software properties according to the embodiment of the present invention.

### DESCRIPTION OF THE PREFERRED EMBODIMENTS

The present invention will be described in detail with reference to the accompanying drawings below. Here, when the description is repetitive and detailed descriptions of well-known functions or configurations would unnecessarily obscure the gist of the present invention, the detailed descriptions will be omitted. The embodiments of the present invention are provided to complete the explanation of the present invention for those skilled in the art. Therefore, the shapes and sizes of components in the drawings may be exaggerated to provide a more exact description.

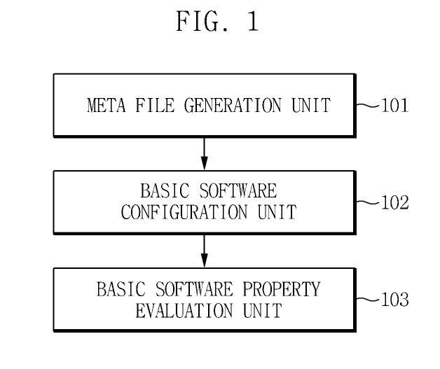

FIG. 1 is a view schematically illustrating an apparatus for evaluating AUTOSAR meta file-based basic software properties according to an embodiment of the present invention.

Referring to FIG. 1, the apparatus for evaluating AUTOSAR meta file-based basic software properties according to the embodiment of the present invention includes a meta file generation unit 101, a basic software configuration unit 102, and a basic software property evaluation unit 103. The apparatus for evaluating AUTOSAR meta file-based basic software properties shown in FIG. 1 is according to an embodiment of the present invention, all the blocks shown in FIG. 1 are not essential components, and some of the blocks may be added, modified, or deleted in other embodiments.

The meta file generation unit 101 generates the meta file properties of an AUTOSAR meta file. According to an embodiment, the meta file generation unit 101 may generate multiplicity-related properties used to evaluate multiplicity and configured to include lower-multiplicity and upper-multiplicity. According to another embodiment, the meta file generation unit 101 may generate reference-related properties used to evaluate reference properties and configured to include one or more of reference parameter definition (REFERENCE-PARAM-DEF), an external reference parameter definition (FOREIGN-REFERENCE-PARAM-DEF), choice reference parameter definition (CHOICE-REFERENCE-PARAM-DEF), and name reference parameter definition (SYMBOLIC-NAME-REFERENCE-PARAM-DEF). According to another further embodiment, the meta file generation unit 101 may generate hierarchy-related properties used to evaluate hierarchy properties and configured to include a parameter configuration container definition (PARAM-CONF-CONTAINER-DEF) and a choice container definition (CHOICE-CONTAINER-DEF).

Table 1 shows properties generated using the meta file generation unit of the apparatus for evaluating AUTOSAR meta file-based basic software properties according to the embodiment of the present invention.

TABLE 1

| Evaluation Item | Meta File Property |
|---|---|
| Multiplicity | LOWER-MULTIPLICITY |
| | UPPER-MULTIPLICITY |
| Reference Property | REFERENCE-PARAM-DEF |
| | FOREIGN-REFERENCE-PARAM-DEF |
| | CHOICE-REFERENCE-PARAM-DEF |
| | SYMBOLIC-NAME-REFERENCE-PARAM-DEF |
| Hierarchy Property | PARAM-CONF-CONTAINER-DEF |
| | CHOICE-CONTAINER-DEF |

Each of the properties will be described later when related evaluation items are described.

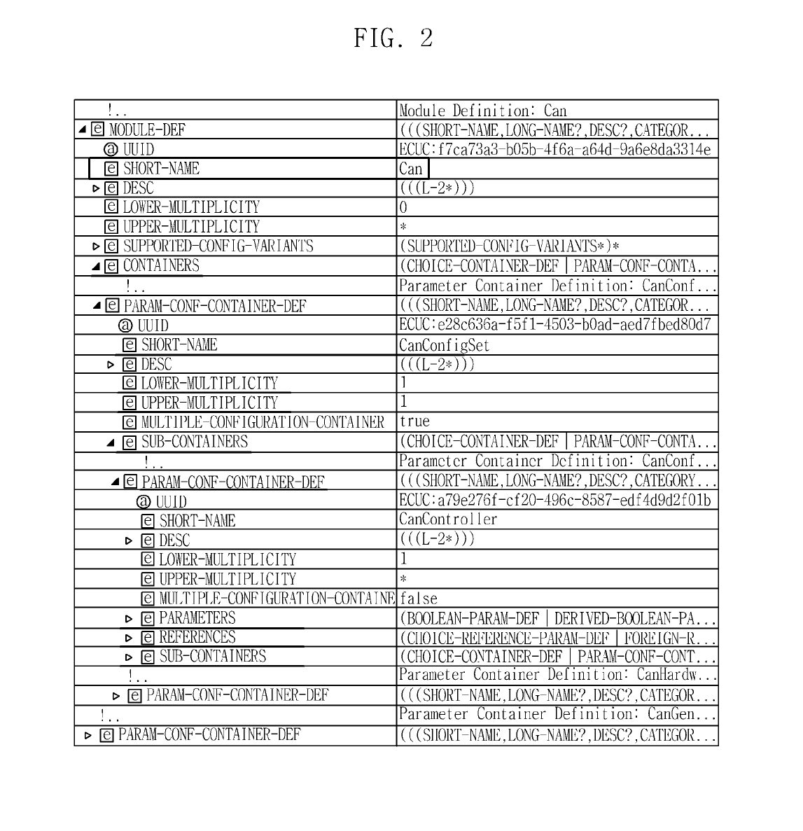

FIG. 2 is a view illustrating an example of a meta file used in the apparatus for evaluating AUTOSAR meta file-based basic software properties according to the embodiment of the present invention.

FIG. 2 illustrates reference data, that is, a part of the meta file “AUTOSAR EcuParamDef.arxml”, which is provided from AUTOSAR and is a reference for the configuration of basic software modules. Referring to FIG. 2, the meta file generates a container, lower-multiplicity, upper-multiplicity and a sub-container for each module. The apparatus for evaluating AUTOSAR meta file-based basic software properties according to the embodiment of the present invention may evaluate basic software properties using the meta file as shown in FIG. 2. The meta file shown in FIG. 2 is an example, and the apparatus for evaluating AUTOSAR meta file-based basic software properties according to the embodiment of the present invention may evaluate basic software properties using a meta file which has configuration that is different from that of the meta file shown in FIG. 2.

Referring to FIG. 1 again, the basic software configuration unit 102 sets the basic software properties of a basic software configuration file. According to an embodiment, the basic software configuration unit 102 may set the basic software properties of the basic software configuration file by receiving input from a user. Further, the basic software configuration unit 102 may set the basic software properties using an AUTOSAR development support tool.

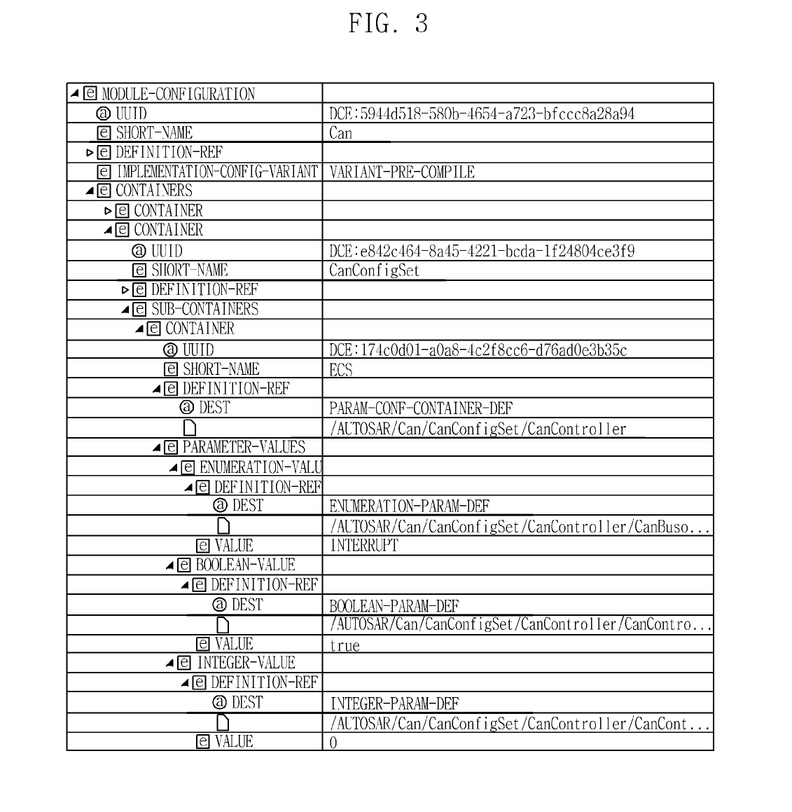

FIG. 3 is a view illustrating an example of a basic software configuration file set using the apparatus for evaluating AUTOSAR meta file-based basic software properties according to the embodiment of the present invention.

FIG. 3 illustrates reference data, that is, a part of a basic software configuration file (*.arxml) which stores basic software properties which are set using the AUTOSAR development support tool. The purpose of the apparatus for evaluating AUTOSAR meta file-based basic software properties according to the embodiment of the present invention is to verify whether the basic software configuration file is set in conformity with the standard. That is, the apparatus for evaluating AUTOSAR meta file-based basic software properties according to the embodiment of the present invention verifies whether the basic software configuration file is set in conformity with the AUTOSAR standard using the meta file properties of the AUTOSAR meta file.

Referring to FIG. 1 again, the basic software property evaluation unit 103 evaluates the basic software properties in order to determine whether the basic software properties, set by the basic software configuration unit 102, are set in conformity with the AUTOSAR standard using the meta file properties generated by the meta file generation unit 101. The process of evaluating the basic software properties using the basic software property evaluation unit 103 includes verification processes which differ depending on evaluation items. That is, the verification processes differ depending on whether an item to be evaluated corresponds to multiplicity evaluation, reference property evaluation, or hierarchy property evaluation. The verification process using the basic software property evaluation unit 103 based on the above-described evaluation items will be described in detail below with reference to the drawings.

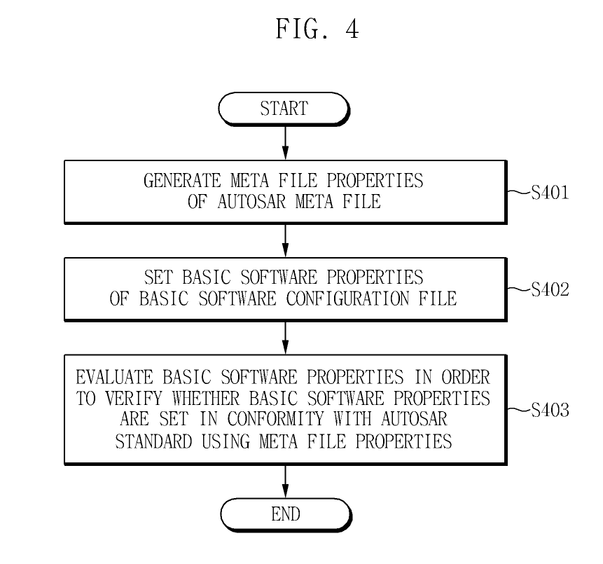

FIG. 4 is a flowchart illustrating a method for evaluating AUTOSAR meta file-based basic software properties according to an embodiment of the present invention.

Referring to FIG. 4, when the method for evaluating AUTOSAR meta file-based basic software properties according to the embodiment of the present invention starts, the meta file properties of an AUTOSAR meta file are first generated at step S401. According to a first embodiment, the multiplicity-related properties, used to perform the multiplicity evaluation and configured to include the lower-multiplicity and the upper-multiplicity, may be generated at step S401. According to a second embodiment, the reference-related properties, used to perform the reference property evaluation and configured to include one or more of the reference parameter generation, the external reference parameter generation, the choice reference parameter generation, and the name reference parameter generation, may be generated at step S401. According to a third embodiment, the hierarchy-related properties, used to perform the hierarchy property evaluation and configured to include the parameter configuration container definition or the choice container definition, may be generated at step S401.

When the meta file properties are generated at step S401, the basic software properties of the basic software configuration file are set at step S402. According to the first embodiment, the basic software properties of the basic software configuration file may be set by receiving input from a user at step S402. Further, the basic software properties may be set using an AUTOSAR development support tool at step S402.

Thereafter, the basic software properties are evaluated in order to verify whether the basic software properties are set in conformity with the AUTOSAR standard using the meta file properties at step S403. The process of evaluating the basic software properties at step S403 includes verification processes which differ depending on evaluation items. That is, the verification processes differ depending on whether an item to be evaluated corresponds to multiplicity evaluation, reference property evaluation, or hierarchy property evaluation. The verification process at step S403 depending on evaluation items will be described in detail below with reference to the accompanying drawings.

The process of evaluating properties is performed in the method for evaluating AUTOSAR meta file-based basic software properties shown in FIG. 4 as in the apparatus for evaluating AUTOSAR meta file-based basic software properties according to the embodiment of the present invention. Therefore, the same description in FIG. 1 is applied if there is no specific mention thereof. In FIG. 4, not all of the steps in FIG. 4 are essential, and some of the steps may be added, modified, or removed in other embodiments as in FIG. 1. Further, each step of the flowchart is not limited to the illustrated order and the order thereof may be modified or changed if necessary.

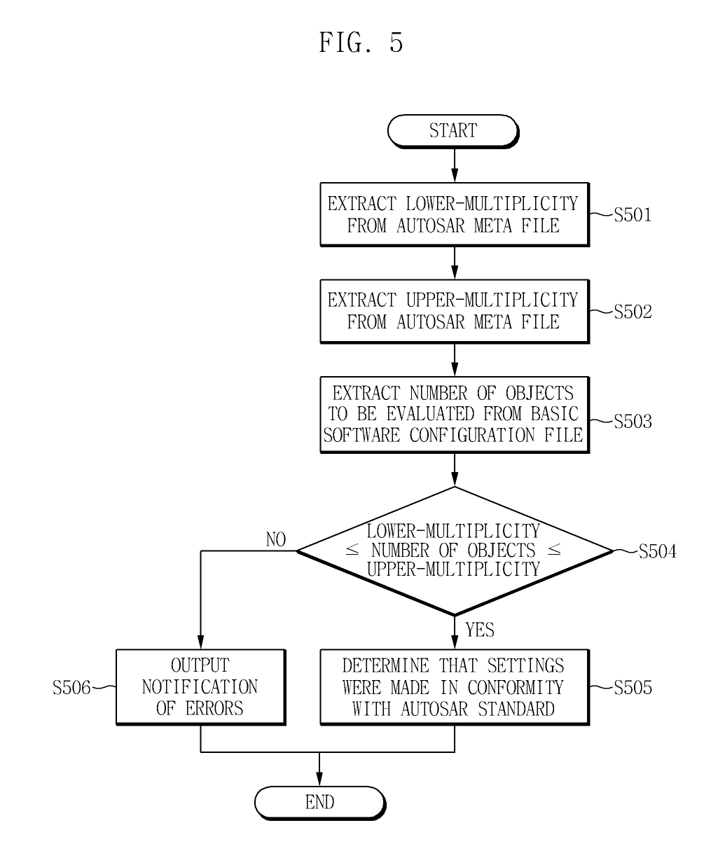

FIG. 5 is a flowchart illustrating a process of evaluating multiplicity using the apparatus and method for evaluating AUTOSAR meta file-based basic software properties according to the embodiment of the present invention.

The multiplicity evaluation process shown in FIG. 5 may be performed by the basic software property evaluation unit 103 of FIG. 1 and may be performed at step S403 of FIG. 4.

The multiplicity evaluation is performed to determine whether the number of objects which are the targets of the evaluation falls in a permitted range. For this purpose, the lower-multiplicity, which is included in the multiplicity-related properties, is first extracted from the AUTOSAR meta file at step S501, and then another multiplicity-related property, that is, the upper-multiplicity is extracted at step S502. Thereafter, the number of objects, which are the targets of the evaluation, is extracted from the basic software configuration file at step S503. Here, the multiplicity-related properties and the number of objects may be extracted using Xpath at steps S501 to S503. For example, the Xpath sentence used to extract “LOWER-MULTIPLICITY” at step S501 is “//MODULE-DEF[SHORT-NAME=‘aaa’]/CONTAINERS/PARAM-CONF-CONTAINER-DEF[SHORT-NAME=‘bbb’]/LOWER-MULTIPLICTY”, and the Xpath sentence used to extract the number of objects at step S503 is “count(//CONTAINER/DEFINITION-REF/text( )=‘bbb’)”. The Xpath sentence used to obtain relevant information is in conformity with an XPath language rule, and may be prepared in various manners in order to accomplish the object of the present invention. The above-described sentences are described according to an embodiment. Hereinafter the XPath sentences used to obtain various types of information will be omitted without being separately described.

When the multiplicity-related properties and the number of objects are extracted at steps S501 to S503, it is evaluated whether the extracted number of objects is greater than the lower-multiplicity and less than the upper-multiplicity at step S504, that is, it is evaluated whether “LOWER-MULTIPLICITY≦the number of objects≦UPPER-MULTIPLICITY” in numerical expression at step S504. Here, if the numerical expression is satisfied at step S504, it is determined that settings were made in conformity with the AUTOSAR standard at step S505. Otherwise, the notification of errors is output at step S506.

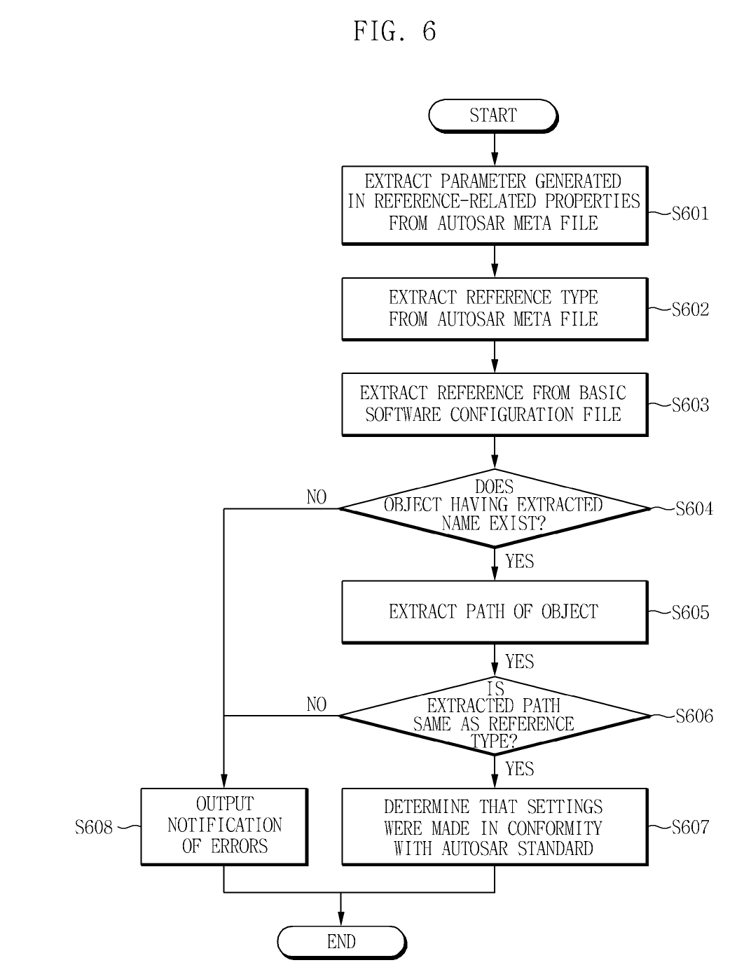

FIG. 6 is a flowchart illustrating a process of evaluating reference properties using the apparatus and method for evaluating AUTOSAR meta file-based basic software properties according to the embodiment of the present invention.

The reference property evaluation process shown in FIG. 6 may be performed by the basic software property evaluation unit 103 of FIG. 1 and may be performed at step S403 of FIG. 4.

The reference property evaluation is performed to evaluate whether other basic software modules, which are referred to, are normally referred to in conformity with the generation of the AUTOSAR meta file in order to operate the basic software module. For this purpose, a parameter generated in the reference-related properties is extracted from the AUTOSAR meta file at step S601. That is, a parameter, generated in the reference-related properties including one or more of the reference parameter generation, the external reference parameter generation, the choice reference parameter generation, and the name reference parameter generation, is extracted at step S601. Thereafter, a reference type which is generated in the AUTOSAR meta file is extracted such that the parameter refers to the type at step S602.

When the reference type was extracted at step S602, the reference value of the parameter, which was set in the basic software configuration file, is extracted at step S603. Further, it is evaluated whether an object corresponding to a name, extracted at step S603, exists at step S604. If the corresponding object exists, the path of the object is extracted at step S605. Otherwise, notification of errors is output at step S608. It is determined whether, as the result of the extraction of the path of the object at step S605, the extracted path is identical to the reference type at step S606. If the extracted path is identical to the reference type, it is determined that settings were made in conformity with the AUTOSAR standard at step S607. Otherwise, notification of errors is output at step S608.

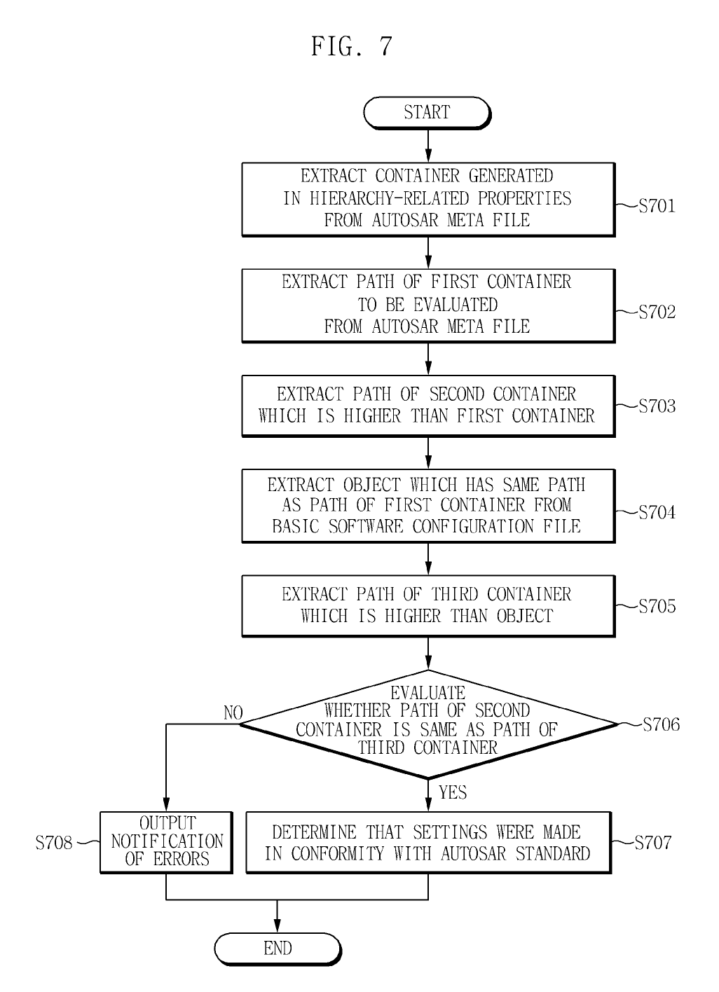

FIG. 7 is a flowchart illustrating a process of evaluating hierarchy properties using the apparatus and method for evaluating AUTOSAR meta file-based basic software properties according to the embodiment of the present invention.

The hierarchy property evaluation process shown in FIG. 7 may be performed by the basic software property evaluation unit 103 of FIG. 1 and may be performed at step S403 of FIG. 4.

The hierarchy property evaluation is performed to evaluate whether the interconnection (high level-low level) between the objects of the basic software modules is proper. For this purpose, a container generated in the hierarchy-related properties is first extracted from the AUTOSAR meta file at step S701. That is, a container, generated in the parameter configuration container definition or the choice container definition of the hierarchy-related properties, is extracted at step S701. Thereafter, the path of a first container to be evaluated is extracted from the AUTOSAR meta file at step S702, and the path of a second container, which is the higher container of the first container, is extracted at step S703. Thereafter, an object which has the same path as the path of the first container is extracted from the basic software configuration file at step S704, and then the path of a third container, which is the higher container of the object, is extracted at step S705. When the paths of the respective second container and the third container are extracted at steps S701 to S705 as described above, it is evaluated whether the path of the second container is the same as the path of the third container at step S706. If the path of the second container is the same as the path of the third container, it is determined that settings were made in conformity with the AUTOSAR standard at step S707. Otherwise, notification of errors is output at step S708.

The above-described method for evaluating AUTOSAR meta file-based basic software properties, the multiplicity evaluation process, the reference property evaluation process, and the hierarchy property evaluation process have been described with reference to the flowcharts shown in the drawings. For the purpose of brief description, the method is illustrated and described using a series of blocks. However, the present invention is not limited to the order of the blocks. Some of the blocks may occur with other blocks in an order that is different from that illustrated and described in the present specification or may occur at the same time. Various different orders of branches, flow paths, and blocks, which are used to accomplish the same or similar results, may be implemented. Further, not all of the blocks may be required in order to implement the method described in the present specification.

According to an aspect of the present invention, the present invention may provide an apparatus and method for evaluating AUTOSAR meta file-based basic software properties, which evaluates basic software properties using an AUTOSAR meta file, thereby verifying if the properties of an electronic software platform are normally set in conformity with an AUTOSAR standard, which is the standard of a vehicle's electronic software platform architecture.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for evaluating Automobile Open System Architecture (AUTOSAR) meta file-based basic software properties, the apparatus comprising:
a meta file generation unit for generating meta file properties of an AUTOSAR meta file;
a basic software configuration unit for setting basic software properties of a basic software configuration file; and
a basic software property evaluation unit for evaluating basic software properties using the meta file properties in order to determine whether the basic software properties were set in conformity with an AUTOSAR standard.

2. The apparatus as set forth in claim 1, wherein the meta file generation unit generates multiplicity-related properties used to perform a multiplicity evaluation and configured to include lower-multiplicity and upper-multiplicity.

3. The apparatus as set forth in claim 2, wherein the basic software property evaluation unit extracts the multiplicity-related properties from the AUTOSAR meta file, extracts a number of objects, which are evaluation targets, from the basic software configuration file, and determines that settings were made in conformity with the AUTOSAR standard when the number of objects is greater than the lower-multiplicity and less than the upper-multiplicity.

4. The apparatus as set forth in claim 1, wherein the meta file generation unit generates reference-related properties used to perform a reference property evaluation and configured to include one or more of reference parameter generation, an external reference parameter generation, choice reference parameter generation, and name reference parameter generation.

5. The apparatus as set forth in claim 4, wherein the basic software property evaluation unit extracts a parameter generated in the reference-related properties from the AUTOSAR meta file, extracts a reference type generated in the AUTOSAR meta file such that the parameter refers to the reference type, extracts a reference set in the basic software configuration file for the parameter, extracts a path of an object when the object having a name corresponding to the extracted reference exists, and determines that settings were made in conformity with an AUTOSAR standard when the extracted path is same as the reference type.

6. The apparatus as set forth in claim 1, wherein the meta file generation unit generates hierarchy-related properties used to perform a hierarchy property evaluation and configured to include a parameter configuration container definition and a choice container definition.

7. The apparatus as set forth in claim 6, wherein the basic software property evaluation unit extracts a container generated in the reference-related properties from the AUTOSAR meta file, extracts a path of a first container to be evaluated from the AUTOSAR meta file, extracts a path of a second container which is a higher container of the first container, extracts an object having a path that is same as the path of the first container from the basic software configuration file, extracts a path of a third container which is a higher container of the object, and determines that settings were made in conformity with the AUTOSAR standard when the path of the second container is same as the path of the third container.

8. A method for evaluating AUTOSAR meta file-based basic software properties, comprising:
generating meta file properties of an AUTOSAR meta file;
setting basic software properties of a basic software configuration file; and
evaluating basic software properties using the meta file properties in order to determine whether the basic software properties were set in conformity with an AUTOSAR standard.

9. The method as set forth in claim 8, wherein the generating comprises generating multiplicity-related properties used to perform a multiplicity evaluation and configured to include lower-multiplicity and upper-multiplicity.

10. The method as set forth in claim 9, wherein the evaluating the basic software properties comprises:
extracting the multiplicity-related properties from the AUTOSAR meta file;
extracting a number of objects, which are evaluation targets, from the basic software configuration file; and
determining that settings were made in conformity with the AUTOSAR standard when the number of objects is greater than the lower-multiplicity and less than the upper-multiplicity.

11. The method as set forth in claim 8, wherein the generating the meta file properties comprises generating reference-related properties used to perform a reference property evaluation and configured to include one or more of reference parameter generation, an external reference parameter generation, choice reference parameter generation, and name reference parameter generation.

12. The method as set forth in claim 11, wherein the evaluating the basic software properties comprises:
extracting a parameter generated in the reference-related properties from the AUTOSAR meta file;
extracting a reference type generated in the AUTOSAR meta file such that the parameter refers to the reference type;
extracting a reference set in the basic software configuration file for the parameter, and extracting a path of an object when the object having a name corresponding to the extracted reference exists; and
determining that settings were made in conformity with an AUTOSAR standard when the extracted path is same as the reference type.

13. The method as set forth in claim 8, wherein the generating the meta file properties comprise generating hierarchy-related properties used to perform a hierarchy property evaluation and configured to include a parameter configuration container definition and a choice container definition.

14. The method as set forth in claim 13, wherein the evaluating the basic software properties comprises:
extracting a container generated in the reference-related properties from the AUTOSAR meta file;
extracting a path of a first container to be evaluated from the AUTOSAR meta file;
extracting a path of a second container which is a higher container of the first container;
extracting an object having a path that is same as the path of the first container from the basic software configuration file;
extracting a path of a third container which is a higher container of the object; and
determining that settings were made in conformity with the AUTOSAR standard when the path of the second container is same as the path of the third container.
